(19) United States
(12) Patent Application Publication
(10) Pub. No.: US 2021/0022292 A1
(43) Pub. Date: Jan. 28, 2021

(54) ROBOT AND METHOD FOR CONTROLLING THE ROBOT

(71) Applicant: VITIROVER, Saint-Emilion (FR)

(72) Inventor: Xavier DAVID BEAULIEU, Saint-Emilion (FR)

(73) Assignee: VITIROVER, Saint-Emilion (FR)

(21) Appl. No.: 17/065,935

(22) Filed: Oct. 8, 2020

Related U.S. Application Data
(63) Continuation-in-part of application No. PCT/EP2019/058942, filed on Apr. 9, 2019.
Application No. PCT/EP2019/058942 is a continuation-in-part of application No. PCT/EP2018/058990, filed on Apr. 9, 2018.
Application No. PCT/EP2018/058990 is a continuation-in-part of application No. PCT/EP2018/058989, filed on Apr. 9, 2018.
Application No. PCT/EP2018/058989 is a continuation-in-part of application No. PCT/EP2018/058987, filed on Apr. 9, 2018.

(30) Foreign Application Priority Data
Apr. 9, 2018 (EP) PCT/EP2018/058991

(51) Int. Cl. A01D 75/18; A01D 67/00; A01D 69/02; A01D 34/00

(52) U.S. Cl. CPC A01D 75/185; A01D 67/00; A01D 2101/00; A01D 34/008; A01D 69/02

(57) ABSTRACT

A robot includes a first axle and a second axle. A first axle housing includes a first transversal axle connected to a rigid structure by a hinge having a first degree of freedom in rotation around a first axis which is vertical and a second degree of freedom in rotation around a second axis which is perpendicular to the first axis and to a first transversal axis. The first transversal axle is equipped on either side with a motor, each motor having a stator and a rotor rotatably mounted to a respective wheel to provide steering and propulsion functions.

### CROSS-REFERENCE TO RELATED APPLICATIONS

This application is a Continuation-in-Part of: international PCT Patent Application Serial No. PCT/EP2019/058942 filed on Apr. 9, 2019, PCT Patent Application Serial No. PCT/EP2018/058990 filed Apr. 9, 2018, PCT Patent Application Serial No. PCT/EP2018/058989 filed Apr. 9, 2018, and PCT Patent Application Serial No. PCT/EP2018/058987 filed Apr. 9, 2018. PCT Patent Application Serial No. PCT/EP2019/058942 claims priority to PCT Patent Application Serial No. PCT/EP2018/058991 filed on Apr. 9, 2018. All of the above applications are incorporated by reference herein.

### TECHNICAL FIELD

The invention relates to a robot having a chassis and a method for controlling the robot. It also relates to a robot having a chassis and a free rear axle housing with two axes of rotation with respect to the chassis. It also relates to a connecting module for a brush cutter, edge trimmer or the like, comprising a chassis and a cutting module. It also relates to a cutting head for a brush cutter, edge trimmer or the like. More precisely, it relates to a cutting head comprising a comb and a plurality of motorized disks aligned transversely, rotatably mounted on the comb, wherein the motorized disk support a plurality of articulated blades on the disk and adapted to extend radially relative to the rotation axis of said disks under the effect of the centrifugal force.

### SUMMARY

An object of the invention is, in particular, to provide a robot with a low propulsion consumption. Another object of the invention is, in particular, to provide a robot having a chassis and a free rear axle housing with two axes of rotation with respect to the chassis which ensure a longer life of the chassis as compared to the known robot having a chassis and a free rear axle housing with two axes of rotation of the previous art. Another object of the invention is to provide a robot a chassis and a free rear axle housing with two axes of rotation with respect to the chassis which is more suitable for its use in the agricultural fields as compared to the known robot having a chassis and a free rear axle housing with two axes of rotation of the previous art.

In a configuration such as vineyard, a park, a photovoltaic field, many obstacles are present (vines, pegs, clods, potholes, slope, counter-slope, abandoned objects, etc.). A robot in such a configuration must face all the obstacles without ever being “jammed” and thus forced to stop his automatic work. It should be noted that given a very low speed of movement of the robot and a low weight of the robot, these contacts have no effect on the vines.

The best solution for cutting the grass closer to the grass is to come into contact with the obstacle. Therefore, the robot is not configured to avoid the obstacle but to detect it as quickly as possible. In these agricultural fields, the number of obstacles per unit area, and therefore the number of contacts between the robot and these obstacles per unit of time can be as important as one obstacle every 12 seconds in a vineyard planted at 6600 feet per hectare (plus 20% of stakes), at a speed of 350 m/h.

The advantages of a front-cutting module are known, such as being used in difficult access places. To the intent to cut all the grass on the cutting front, and because two blades of two consecutive cutting disks should not meet, two consecutive motorized disks are placed on two parallel, but different, plans. Therefore two blades of two consecutive cutting disks do not meet.

Designing such a cutting head with different plans makes the production of said cutting head expensive and complicated. Also, a same grass may be cut by two blades of different motorized disks, therefore being cut at two different levels. To this effect, according to a first aspect of the invention, the invention relates to, robot comprising a first axle and a second axle, the first axle housing comprising a first transversal axle connected to a rigid structure by a hinge having a first degree of freedom in rotation around a first axis which is vertical and a second degree of freedom in rotation around a second axis which is perpendicular to the first axis and to the first transversal axis, and the axle of the first transversal axle being equipped on either side with a motor, each motor having a stator part intended for to be fixed to the first transversal axle and a rotor part to be rotatably mounted to a respective wheel to provide steering and propulsion functions.

The robot might be further arranged to receive electronic controls configured to control each of the motors fitted to said axle housing. According to further non-limitative features of the invention, either taken alone or in all technically feasible combinations:
the electronic controls are configured to drive each motor independently;
the hinge is placed on the center of the transversal axis;
the center of gravity of the robot is located between the four wheels;
the chassis is shell that goes down between the two axles to lower the center of gravity;
the rigid structure is a shell;
the robot comprises a unique battery;
the robot comprises a frontal cutting module place between two wheels, either on the front or on the rear of the robot, and the two other wheels are steering wheels;
the 4 wheels are driving wheels;
the electronic controls are configured to implement a robot moving strategy towards a predetermined destination point by minimization of the distance to the predetermined destination point, the strategy being locally random;
the robot comprises means for detecting an obstacle.
the means for detecting the obstacle are configured to detect an obstacle by combination of two or more of the following parameters:
   counter electromotive force of one of the motor;
   differential of inertial components for detection of acceleration and/or acceleration variation;
   angular sensor of steering wheels;
   geographical localization;
the electronic controls are configured to invert the direction of movement of the robot when an obstacle is detected.
the robot comprises a frontal cutting module place between two wheels, and, in the event that the obstacle detected is on the side of the cutting tool, the electronic controls are configured to stop the robot and to select a steering direction to circumvent the obstacle before inverting the direction of the movement;
the robot comprises an angular sensor of the angle formed by the transverse axis relative to the frame, said angular sensor comprising a flag fixed in rotation with the first axis and a rangefinder to measure the distance between the flag and a fixed point of the rigid structure.

Preferably, the axle housing is rotatable around two axes of rotation with respect to a chassis of the robot. In an embodiment, the rear axle is a free rear axle with two axes of rotation with respect to the chassis, which comprises a stop device for circumscribing in space the displacements of the rear axle. Preferably, the stop device comprises a plate of rectangular shape defining a main plane and a center of the rectangular shape.

According to an embodiment, the plane orthogonal to the main plane and extending in the longitudinal direction of the plate and passing through the center of the rectangle is a plane of symmetry of the stop device. Preferably, the plane orthogonal to the main plane and extending in the direction transverse to the longitudinal direction of the plate and passing through the center of the rectangle is a plane of symmetry of the stop device. For example, four screw passages may be formed at the corners of a rectangle centered on the center of the plate.

On an embodiment, four damper passages are formed in the plate at the corners of a rectangle centered on the center of the plate. Preferably, the stop device has four stops distributed symmetrically with respect to the two planes of symmetry of the stop device. For example, a stop has a right-angled triangle section whose right angle is disposed at one end of the rectangle forming the plate, one side of the right angle being oriented in the longitudinal direction of the plate, the other side the right angle being directed in the direction of a longitudinal plane perpendicular to the main plane. Preferably, a vertical section transverse to the longitudinal direction of the plate, the plate is hollowed out on a lower central portion to form a “H” which upper left and right interior angles are provided with fillets.

The invention also relates to a method of controlling a robot comprising an axle housing arranged to receive two wheels and intended to provide steering and propulsion functions of said two wheels, said method comprising to control two motors which are housed in said axle housing, on either side, each motor having a stator part intended for to be fixed to the axle housing and a rotor part to be rotatably mounted to said wheel, said robot being further arranged to receive control electronics configured to control each of the motors fitted to said axle housing. According to another aspect, the invention relates to a connecting module for a brush cutter, edge trimmer or the like, comprising a chassis and a cutting module, said module being intended to be connected to said chassis, on the one hand, by flexible damping elements and, on the other hand, fixed to said cutting module, said module being equipped with position sensors of said cutting module with respect to said chassis. Preferably, the connection between said connecting module and the chassis has the degrees of freedom, around the pitch and roll axis, according to the mowing direction of the brush cutter, edge trimmer or the like. The position sensors may comprise an electronic inertial measurement unit.

According to a second aspect of the invention, the invention relates to a brush cutter, edge trimmer or the like comprising a connecting module as claimed according to the previous aspect of the invention, or one or more of its improvement elements. Preferably, the chassis comprises a processing unit and a controller, the processing unit being configured to detect obstacle by using data provided by the position sensors and to send orders to the controller. In an embodiment, the chassis may further comprise sensors fixed onto it and the processing unit may also be configured to detect obstacle by using data provided by the said sensors.

The sensors may comprise a torque sensor for each of the wheels. The sensors may comprise a geographical position system. The processing unit may be also configured to detect obstacle by using data provided by the controller.

According to a fourth aspect of the invention, a method of detecting an obstacle is provided, comprising the use of a connecting module according to the invention, or one or more of its improvement elements, or the use of a brush cutter, edge trimmer or the like, according to the second aspect of the invention, or one or more of its improvement elements. The invention relates, according to an aspect of the invention, to a cutting head for a brush cutter, edge trimmer or the like, comprising a front cutting module comprising a comb having longitudinally extending teeth and a plurality of N motorized disk aligned transversely, at least one disk of said plurality of motorized disk being rotatably mounted on the comb around a rotation axis, wherein at least one disk of the plurality of motorized disk supports a plurality of articulated blades over the said disk and adapted to extend radially relative to the rotation axis of said disk under the effect of the centrifugal force, said comb having a width at least equal to N times the cut diameter of the cut area of a motorized disk, wherein at least two consecutive motorized disks of said plurality of motorized disks are coplanar and wherein the distance between the axis of said at least two consecutive motorized disks is between 1 and 1,2 times the cut diameter of a disk of said at least two consecutive motorized disks.

Such a cutting head is easier to make than the one according the prior art. Such a cutting head avoid cutting twice the same grass. Preferably, each disk of said plurality of motorized disk is rotatably mounted on the comb around a rotation axis.

Preferably, each disk of the plurality of motorized disk supports a plurality of articulated blades over the said disk and adapted to extend radially relative to the rotation axis of said disk under the effect of the centrifugal force. A blade may be mounted rotatably on the disk on which said blade is articulated. The cut area of a disk is the area cut by all the blades articulated on said disk when the blades are in the extended position. The cut area of the front cutting module is the union of each of the cut area of the motorized disk.

Preferably, each disk of said plurality of motorized disk is driven in rotation by a rotor of a motor, said motor having a stator secured on the front cutting module. Said motor may drive only one disk. For example, such of motor may be a stepper motor.

In an embodiment, the comb may have interposed teeth extending longitudinally along a central axis perpendicular to the axes of two consecutive motorized disks. A comb according to this embodiment does not to leave an uncut grass between the two disks. Preferably, the comb has teeth whose ends extend in an arcuate area.

Advantageously, the comb may have a conformation comprising a passage forming a path for discharging grass cut by the articulated blades. A comb according to this embodiment keeps the teeth clean and not stuck by the cutting grass. The passage may be a means for cutting the grass in a reverse direction.

The rounded shape of the outer tooth might allow to slide on the vine without damaging it. Teeth might help guiding the grass for cutting. The shape of the comb might be designed to protect the cutting discs, so that only the blade is in contact with the grass and/or so that the disc never comes into contact with pebbles, branches, . . . . According to an aspect of the invention, coupling means are provided with a cutting head according to the invention, or one or more of its improvement elements.

According to an aspect of the invention, a scooter is provided with a cutting head according to the invention, or one or more of its improvement elements. According to an aspect of the invention, a segway is provided with a cutting head according to the invention, or one or more of its improvement elements. According to a fifth aspect of the invention, a robot is provided with a cutting head according to the invention, or one or more of its improvement elements.

### BRIEF DESCRIPTION OF THE DRAWINGS

Many other features and advantages of the present invention will become apparent from reading the following detailed description, when considered in conjunction with the accompanying drawings, in which:

FIG. 1 is a perspective view of a mowing robot according to the invention;

FIG. 2 is a perspective view of the bottom of the robot of FIG. 1;

FIG. 3 is another perspective view of FIG. 1;

FIG. 4 is a perspective view of the bottom of the robot of FIG. 1;

FIG. 5 is a perspective view of the rear axle of the robot of FIG. 1;

FIG. 6 is a perspective view of a stop element of the rear axle of FIG. 5;

FIG. 7 is a perspective view and a down section of a stop element of FIG. 6;

FIG. 8 is a multi-view projection, front, top and bottom, left and right, of the stop element of FIG. 6;

FIG. 9 is a perspective view, from the top of the robot of FIG. 1;

FIG. 10 is another perspective view of a mowing robot comprising a connecting module;

FIG. 11 is a cutaway drawing of FIG. 11;

FIG. 12 is a front view of FIG. 11;

FIG. 13 is a left side view of FIG. 11;

FIG. 14 is a top view of FIG. 11;

FIG. 15 is a schematic representation of the mowing robot of FIG. 11;

FIG. 16 is a perspective view of another embodiment of a mowing robot comprising a connecting module;

FIG. 17 is a schematic representation of an embodiment of a cutting head according to the invention;

FIG. 18 is a schematic representation of a scooter according to an embodiment of the invention;

FIG. 19 is a schematic representation of a segway according to an embodiment of the invention;

FIG. 20 is a schematic representation of a robot according to an embodiment of the invention;

FIG. 21 is a schematic representation of another scooter according to an embodiment of the invention; and

FIG. 22 is a schematic representation of another embodiment of a cutting head according to the invention.

### DETAILED DESCRIPTION

The embodiments described hereinafter being in no way limiting, it is possible in particular to consider variants of the invention comprising only a selection of characteristics described, subsequently isolated from the other characteristics described, if this selection of characteristics is sufficient to confer a technical advantage or to differentiate the invention from the state of the art. This selection comprises at least one characteristic, preferably functional without structural details, or with only a part of the structural details if this part only is sufficient to confer a technical advantage or to differentiate the invention from the prior art. The same reference numbers are used for identical elements or elements achieving the same function in the different embodiments of the invention that will be described.

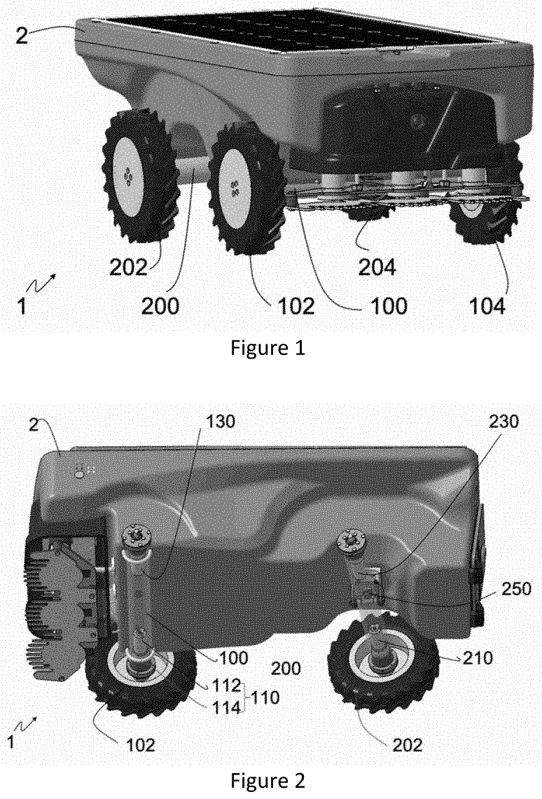

FIG. 1 is a perspective view of a mowing robot 1 according to the invention. The mowing robot 1 is autonomous in energy and comprises a unique battery. The mowing robot 1 comprises a chassis 2, which is a rigid structure, preferably a shell, which is linked to a front axle housing 100 and to a rear axle housing 200.

The front axle housing 100 is fixed to the chassis 2. The front axle housing 100 is linked to two front wheels 102 and 104, which are rotating around the front axle housing 3. At the end of the front axle housing 100 at the wheel 102, the front axle housing 100 comprises a motor 110.

The stator part 112 of the motor is fixed to the front axle housing 100 via a radially external part of a bearing 120 (no shown on the figures). The wheel 102 is fixed to a rotatory part 114 of the motor 110 via the radially internal part of the bearing 120. At the end of the front axle housing 100 at the wheel 104, the front axle housing 100 comprises a motor 130.

The stator part 132 (not shown on the figures) of the motor is fixed to the front axle housing 100 via a radially external part of a bearing 140 (not shown on the figures). The wheel 104 is fixed to a rotatory part 134 (not shown on the figures) of the motor 130 via the radially internal part of the bearing 120. A cable duct 150 is provided to pass electrical wires, which are not shown in the figures, connected to the motors 110 and 130.

The rear axle housing 200 is linked to two rear wheels 202 and 204, which are rotating around the front axle housing 3. The rear axle housing 200 defines a first transversal axle. At the end of the rear axle housing 200 at the wheel 202, the front axle housing 200 comprises a motor 210.

The stator part 212 (not shown on the figures) of the motor is fixed to the rear axle housing 200 via a radially external part of a bearing 220 (not shown on the figures). The wheel 202 is fixed to a rotatory part 214 (not shown on the figures) of the motor 210 via the radially internal part of the bearing 220. At the end of the rear axle housing 200 at the wheel 204, the front axle housing 100 comprises a motor 230.

The stator part 232 (not shown on the figures) of the motor is fixed to the front axle housing 200 via a radially external part of a bearing 240 (not shown on the figures). The wheel 204 is fixed to a rotatory part 234 (not shown on the figures) of the motor 230 via the radially internal part of the bearing 220. Each motor has its stator part fixed to the first transversal axle and its rotor part (brush, brushless) rotatably mounted to a respective wheel (202, 204) to provide steering and propulsion functions. A cable duct 250 is provided to pass electrical wires connected to the motors 210 and 230 which are not shown in the figures.

The rear axle housing 200 is pivotally mounted on a steering pivot 400 around a horizontal axis, which is perpendicular to the longitudinal axis of the rear axle housing 200. The steering pivot 400 is pivotally mounted on a blocking device 500 around a vertical axis. Thus, the rear axle is connected to the rigid structure 2 by a hinge having a first degree of freedom in rotation around a first axis—the vertical axis—which is vertical and a second degree of freedom in rotation around a second axis—the horizontal axis—which is perpendicular to the first axis and to the transversal axis. The hinge is placed on the center of the transversal axis.

The shell 2 goes down between the two axles to lower the center of gravity. The center of gravity of the robot 2 is located between the four wheels 102, 104, 202, 204. The four wheels 102, 104, 202, 204 are driving wheels.

The robot 2 comprises a frontal cutting module located between two wheels 102, 104, on the front of the robot. However, only the two wheels 102, 104, which are located opposite from the frontal cutting module are steering wheels. This is useful to maximize the width of the fontal cutting module. The wheels between which the cutting module is located are only driving wheels, not steering wheels.

The blocking device 500 is adapted to circumscribe in space the displacements of the rear axle housing 200. The blocking device 500 comprises four damping devices 550, as rubber. The damping devices help to ensure long life for the blocking device. The blocking device 500 device is fixed on the chassis 2. Therefore, the chassis 2 can rotate around the forward driving direction and around the vertical direction.

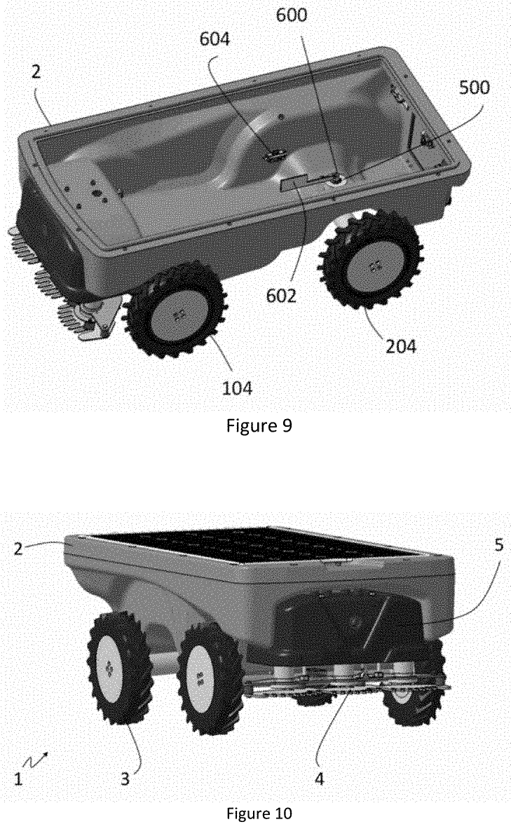

As it might better seen on FIG. 9, the steering pivot 400 is extended by a tube 600 opening into the chassis 2. The tube 600 forms cable duct 600 provided to pass electrical wires, which are not shown in the figures, connected to the motors 210 and 230. The tube 600 is rotationally integral with a flag 602.

The chassis 2 is further provided with a sensor 604 for the angular position of the flag 602. In the example shown in FIG. 9, the sensor 604 of the angular position of the flag 602 is a rangefinder. The rangefinder 604 emits an infrared wave that is reflected on the flag 602, linked to the axis of the rear axle.

The value received by the rangefinder changes according to the distance of the reflective object which is the flag. When the rear axle moves angularly around the vertical axis, the distance of the flag from the rangefinder changes. We can therefore measure the angular position of the rear train. Therefore, the motors 210, 230, are controlled by a controller 300 which is fixed to the chassis 2.

The data provided by the sensor of the angular position of the flag 602 are sent to the controller 300. Therefore, the robot comprises an angular sensor of the angle formed by the transverse axis relative to the frame, the angular sensor comprising the flag 602 fixed in rotation with the first axis and a rangefinder 604 to measure the distance between the flag and a fixed point of the rigid structure 2. Therefore, the angular position of the free rear train is known and the robot might be driven.

The controller 300 controls the motors 210 and 230, independently, in order to change the direction of the mowing robot 1, by pivoting the chassis 2 around the rear axle housing. Therefore, the rear axle housing is a drive and steering axle. In order to rotate the chassis 2 around the rear axle housing, the controller 300 is configured to control the motors 210 and 230 with two different speed rotations.

The motors 110, 130, are also controlled, independently, by the controller 300. In this embodiment, the controller 300 is configured to control the motors 110 and 130 with a same speed rotation. Therefore, the front axle housing is a drive axle but not a steering axle.

The electronic controls 300 are configured to implement a robot moving strategy towards a predetermined destination point by minimization of the distance to the predetermined destination point, the strategy being locally random. The moving strategy might consider the distance to the border of the fields on which is placed the robot. To this end, the robot might consider the geolocation border and the accuracy of the GPS.

The moving strategy might be an opportunistic random displacement locally, mainly opportunistic. The moving strategy might implement derogations to the minimization, by learning derogations by historical data. The moving strategy might implement corner strategy by inversion of changing the predetermined destination point after a given period.

The robot might comprise comprising means for detecting an obstacle. On the embodiment, the electronic controls form part of the means for detecting an obstacle. The electronic controls are further configured to detect an obstacle by combination of two or more of the following parameters:
counter electromotive force of one of the motors;
differential of inertial components (the robot might comprise an IMU or accelerometers, compass and gyroscopic sensors) for detection of acceleration and/or acceleration variation [inconvenience: very noisy];
angular sensor of steering wheels known from the flag 602 and the rangefinder 604,
geographical localization (for example GPS).

The electronic controls 300 might be configured to invert the direction of movement of the robot when an obstacle is detected. In the event that an obstacle detected is on the side of the cutting tool, the electronic controls are configured to stop the robot and to select a steering direction to circumvent the obstacle before inverting the direction of the movement.

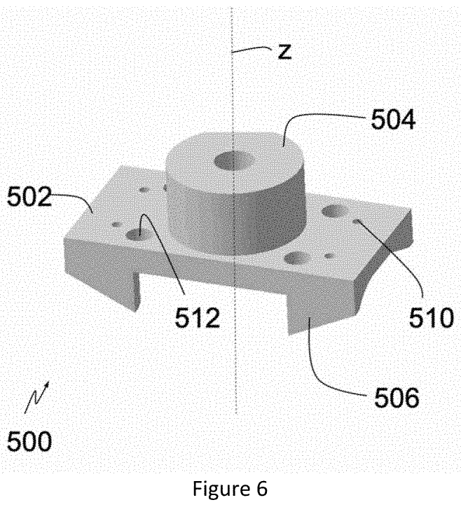

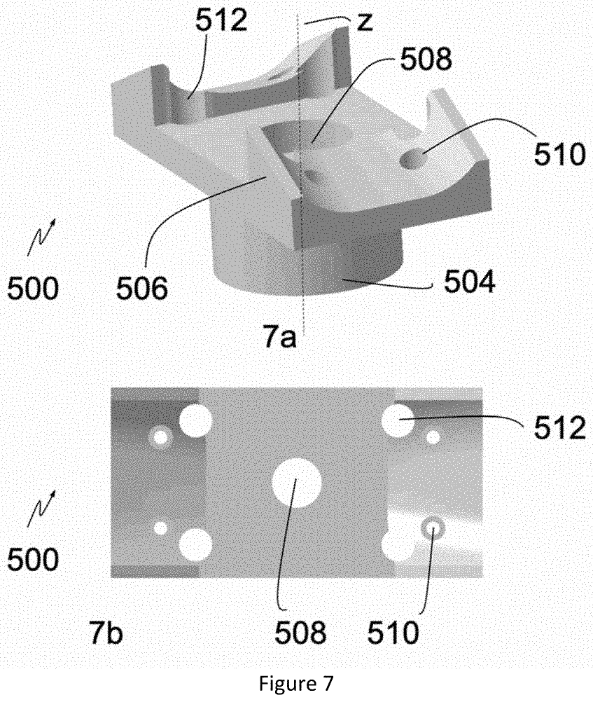

The blocking device 500 might be better seen on FIGS. 6 and 7. The device 500 comprises a plate 502 of rectangular shape centered around a vertical axis z. The plate has a main plane extending in both directions of its rectangular shape.

The device 500 comprises on one side of the plate 502 with respect to the z axis, a cylinder 504 of annular section. The outer diameter of the annular section is smaller than the width of the plate 502. The inside diameter of the annular section is sufficient to allow a passage of electric cable.

As shown in FIG. 7b, the plate 502 has at its center a recess 508 which cooperates with the recess of the cylinder 504 of the annular section. The recess of 508 is of the same diameter as the inside diameter of the annular section. Four passages 510 are formed at the corners of a rectangle centered on the center of the plate 502. The passages 510 allow the fixing by screw and bolt of the plate 502 on the frame 2.

Four other passages 512 are formed in the plate at the corners of a rectangle centered on the center of the plate 502. The passages 512 allow the insertion of the damping device 550 which opens on the opposite side to the cylinder 504 with respect to the z axis.

The plane orthogonal to the main plane and extending in the longitudinal direction of the plate and passing through the middle of the width of the rectangle forming the plate is a plane of symmetry of the device 500. The plane orthogonal to the main plane and extending in the direction transverse to the longitudinal direction of the plate and passing through the middle of the length of the rectangle forming the plate is a plane of symmetry of the device 500. On the side of the plate 502 opposite the cylinder 504 with respect to the axis z, the device 500 has four stops 506 distributed symmetrically with respect to the two planes of symmetry of the device 500.

More specifically, a stop 506 has a right-angled triangle section whose right angle is disposed at one end of the rectangle forming the plate 502, one side of the right angle being oriented in the longitudinal direction of the plate, the other side the right angle being directed in the direction of the axis z opposite to the cylinder 504. The stop has an extension of the right triangle in the direction of the width of the rectangle forming the plate 502.

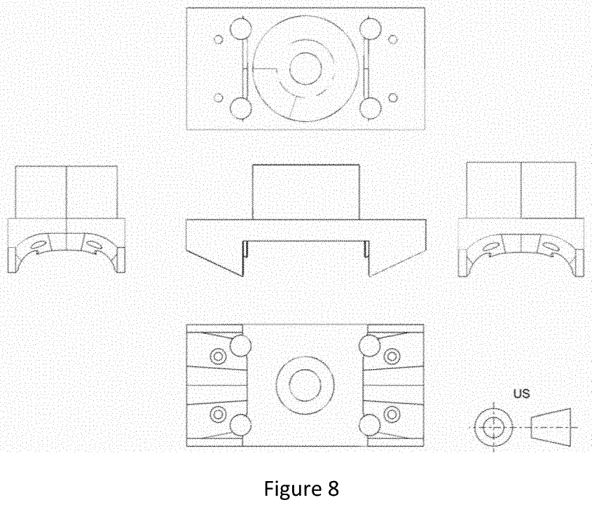

FIG. 8 shows the device 500 in a multi-view projection, front, top and bottom, left and right, according to the US third-angle projection. In a vertical section transverse to the longitudinal direction of the plate 502, the plate 502 is hollowed out on a lower central portion to form a “H” which upper left and right interior angles are provided with fillets.

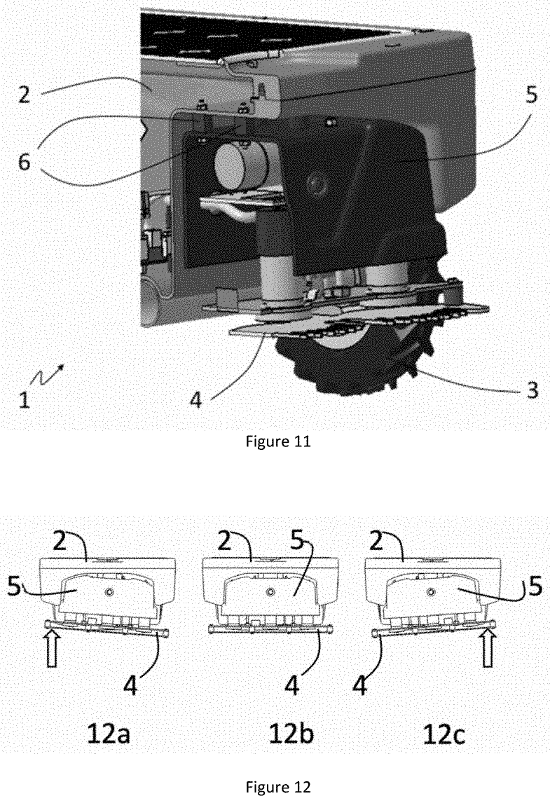

FIG. 10 a perspective view of the mowing robot 1 comprising the chassis 2 suspended on wheels 3, and a cutting module 4. The mowing robot 1 also comprise a connecting module 5. The connecting module 5 is connected to the chassis 2, for example by flexible damping elements 6 (see FIG. 11), such as silent blocks.

The connecting module 5 is fixed to the cutting module 4, for example by means of screws (not shown). As illustrated on FIG. 12, which is a schematically front view of FIG. 1, the connecting module might be in a position which is rotated around a longitudinal axis (according to the mowing direction) of the mowing robot 1. On subFIG. 12a, the right side of the cutting module 4 (according to the mowing direction) is raised while the left side of the cutting module 4 is lowered. On subFIG. 12b, both side of the cutting module 4 are at the same level. On subFIG. 12c, the left side of the cutting module 4 (according to the mowing direction) is lowered while the right side of the cutting module 4 is raised.

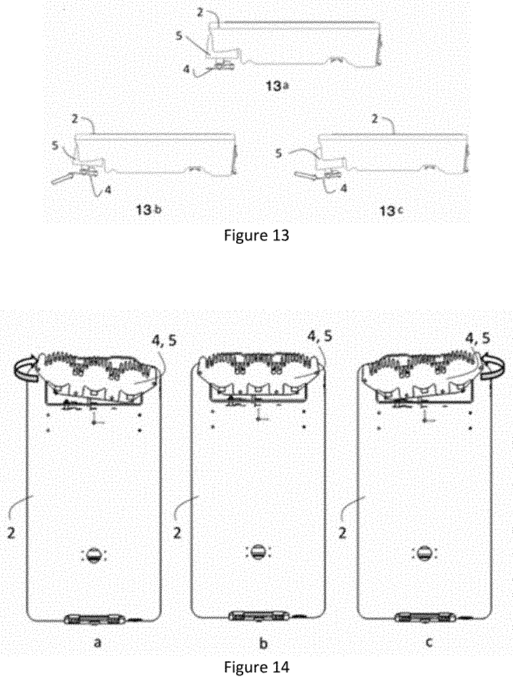

As illustrated on FIG. 13, which is a schematically side view of FIG. 1, taken on the left side of the mowing robot according to the mowing direction, the connecting module might be in a position which is rotated around a transverse axis (according to the mowing direction) of the mowing robot 1. On subFIG. 13a, both side of the cutting module 4 are at the same level. On subFIG. 13b, the front side of the cutting module 4 (according to the mowing direction) is raised while the rear side of the cutting module 4 is lowered. On subFIG. 13c, the front side of the cutting module 4 (according to the mowing direction) is lowered while the rear side of the cutting module 4 is raised.

As illustrated on FIG. 14a, which is a schematically top view of FIG. 1 of the mowing robot, the connecting module might be in a position which is rotated around a vertical axis of the mowing robot 1. On subFIG. 14b, the cutting module 4 is in a nominal direction. On subFIG. 14c, the cutting module 4 is turned around the vertical axis according to a negative angle. On subFIG. 14c, the cutting module 4 is turned around the vertical axis according to a positive angle.

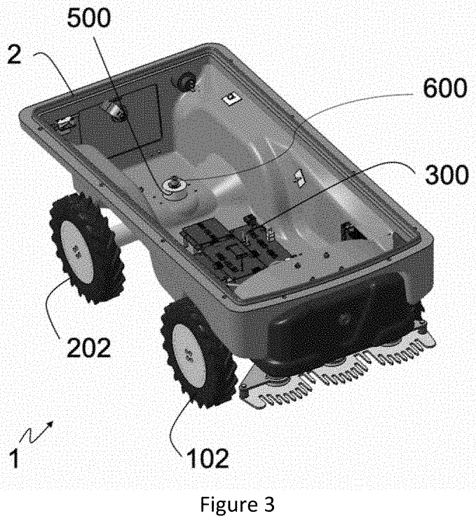

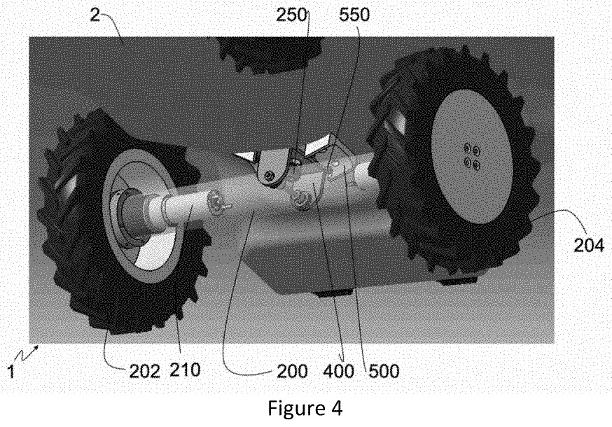

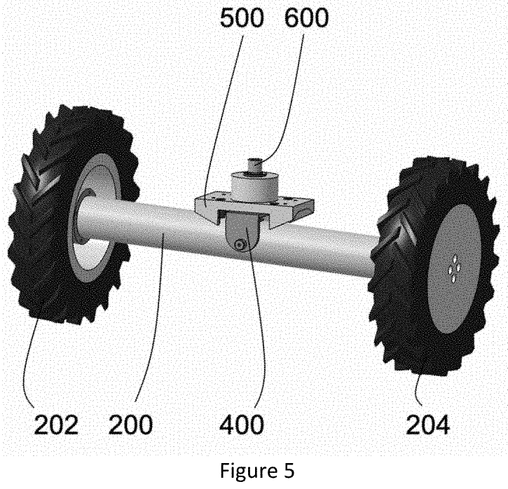

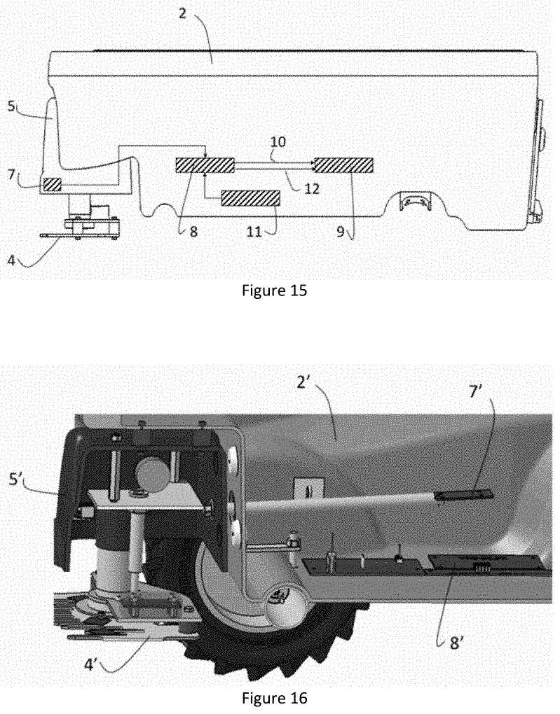

The connection between the connecting module 5 and the chassis 2 has six degrees of freedom: three rotations are shown on FIGS. 3 to 5 while 3 translations are allowed due to the use of damping elements connecting the cutting module 4 to the chassis 2. As schematically represented on FIG. 15 which is a schematic representation of the mowing robot of FIG. 10, the connecting module 5 is equipped with position sensors 7 of said cutting module with respect to said chassis. More specifically, the position sensors 7 comprise an electronic inertial measurement unit called IMU (for the English “Inertial Measurement Unit”). The IMU comprises a gyroscope, an accelerometer.

The mowing robot 1 might comprise a processing unit 8 and a controller 9. The information provided by the position sensors 7 might be sufficient to detect an obstacle. The processing unit 8 might be configured to detect obstacle by using data provided by the position sensors 7. The processing unit 8 might be configured to send orders 10 to the controller 9. In the embodiment illustrated on FIG. 15, the chassis further comprise sensors 11 fixed onto it.

The connecting module 5 is connected to the chassis 2 by a deformable connection of rubber type. In case of encounter of the cutting head with an obstacle, the silent blocs 6 absorb a part of the energy of the shock, and allows a local deformation between the connecting module 5 and the chassis 2. This results in acceleration, rotation, and magnetic field changes between the position sensor 7 and the sensors 8.

The processing unit 8 is also configured to detect obstacle by using data provided by the said sensors 11. The processing unit 9 might be configured to detect the changes between the data provided by the position sensor 7 and the sensors 8. The sensors 11 might comprise a torque sensor for each of the wheels 3. The sensors 11 might comprise a geographical position system.

As illustrated on FIG. 16, the position sensor 7′ might put inside the chassis 2′, while being secured to the connecting module 5, for example via an arm. This makes it possible to move the position sensor 7′, such as a magnetometer, away from the cutting motors and thus from the electromagnetic noise which disturbs the magnetometer. This assembly amplifies the linear acceleration sensed by the inertial unit, which makes the shock detection more effective.

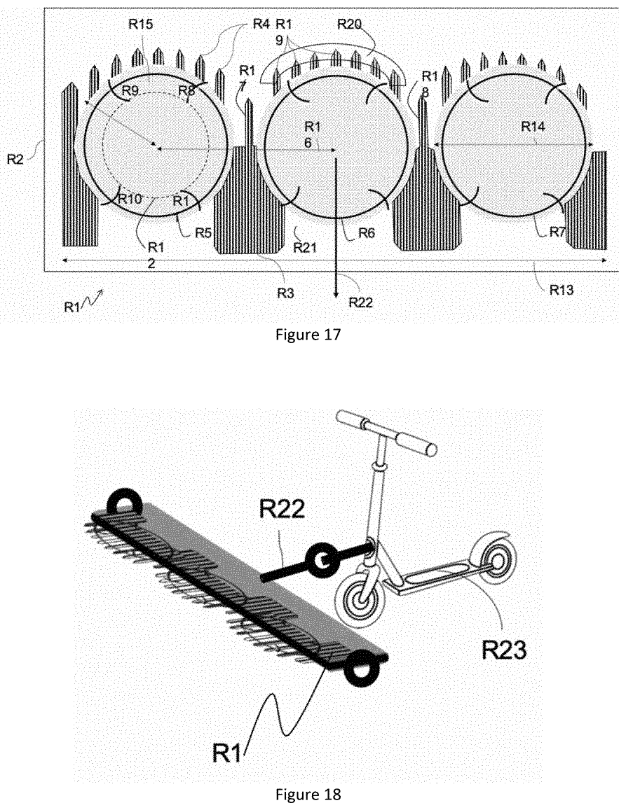

FIG. 17 illustrates a cutting head R1 for a brush cutter, edge trimmer or the like. The cutting head 1 comprising a front cutting module R2. The front cutting module R2 comprises:
a comb R3 having longitudinally extending teeth R4;
a plurality of three motorized disk R5, R6, R7 aligned transversely.

The longitudinal direction is the displacement direction of the cutting head. The transversal direction is the direction which is orthogonal to the displacement direction in a plane which is parallel to the ground on which the cutting head is displaced.

Each disk of the plurality of motorized disk is rotatably mounted on the comb R3 around a rotation axis. Each disk of said plurality of motorized disk is driven in rotation by a rotor of a motor (not shown), said motor having a stator secured on the front cutting module R2. Each disk supports a plurality of articulated blades adapted to extend radially relative to the rotation axis of the disk under the effect of the centrifugal force.

FIG. 17 illustrates three blades R8, R9, R10, fixed on disk R5. The width R13 of the comb R3 is greater than three times the cut diameter R14 of the cut area R15. The cut area R15 of a blade, when moved by the centrifugal force, is a disk represented by a grayed area. The distance R16 between the axis of two consecutive motorized disks such as motorized disks R5 and 6R is between 2 and 2.4 times the radius of the cut area.

The comb R3 has interposed teeth R17 extending longitudinally along a central axis perpendicular to the axes of consecutive motorized disks R5 and R6. The comb R3 has interposed teeth R18 extending longitudinally along a central axis perpendicular to the axes of consecutive motorized disks R6 and R7. The comb R3 has teeth R19 whose ends extend in an arcuate area R20. The comb R3 has a conformation comprising a passage R21 forming a path R22 for discharging grass cut by the blades 8, 9, 10.

The cutting head R1 has a conformation comprising a passage R21. The passage R21 forms a path R22 for discharging grass cut by the articulated blades R8, R9, R10 (see FIG. 1). The passage 21 is a means for cutting the grass in a reverse direction, i.e, in a displacement of the cutting head following the arrow 22.

FIG. 18 is a schematic representation of a scooter R23 according to an embodiment of the invention. The scooter R23 is coupled to the cutting R1 head by means of coupling means R22.

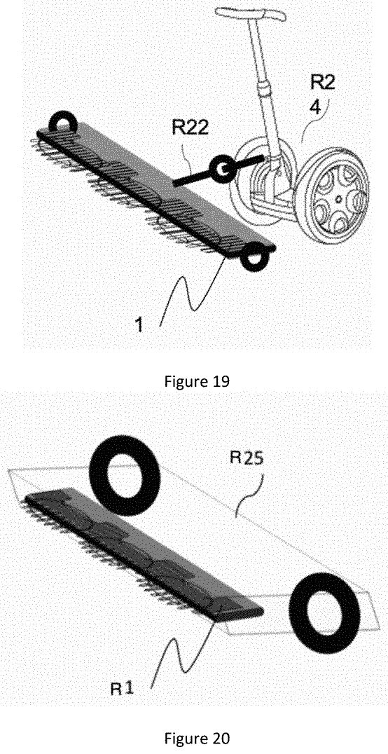

FIG. 19 is a schematic representation of a segway R24 according to an embodiment of the invention. The segway 24 is coupled to the cutting head 1 by means of coupling means 22.

FIG. 20 is a schematic representation of a robot R25 according to an embodiment of the invention. The robot R25 includes the cutting head R1 and is, in the embodiment illustrated, an autonomous robot.

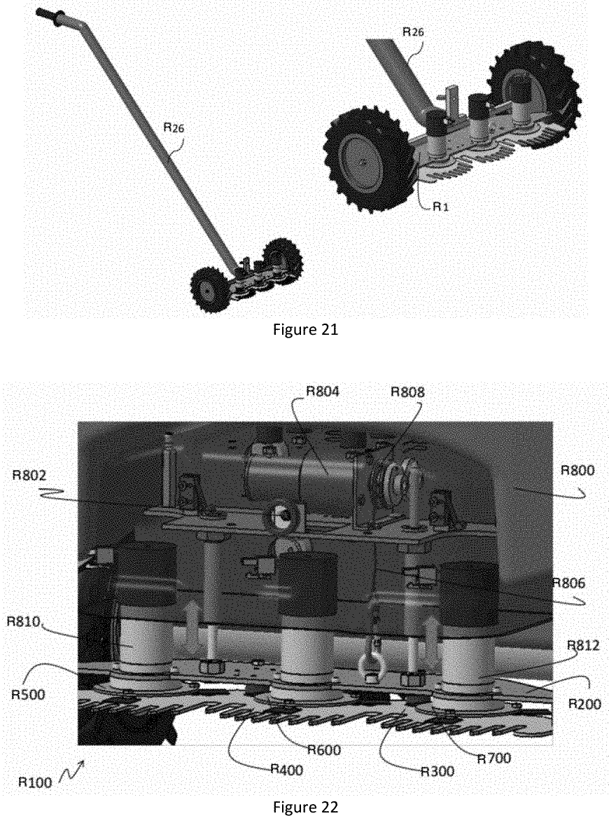

FIG. 21 is a schematic representation of another scooter R26 according to an embodiment of the invention. FIG. 22 is a schematic representation of another embodiment R100 of a cutting head according to the invention. The cutting head R100 comprising a front cutting module R200.

The front cutting module R200 comprises:
a comb R300 having longitudinally extending teeth R400;
a plurality of three motorized disk R500, R600, R700 aligned transversely.

The front cutting module R200 might be can be adjusted in height with respect to a device R800 connected to the robot chassis. For this purpose, the device R800 comprises a switch R802. When the switch R802 is possessed at the top, it causes a height adjustment upwards by operating a motor R804 lifting in one direction. This has the effect of winding a cable R806 on a pulley R808 connected to the rotor portion of the motor R804 and to lift the block R200. This block is in slide connection with two guides R810 and R812. By operating the switch R802 downwards, the opposite occurs.

Of course, the invention is not limited to the examples which have just been described and numerous adjustments can be made to these examples without departing from the scope of the invention. In addition, the various features, forms, variants and embodiments of the invention can be combined with one another in various combinations insofar as they are not incompatible or exclusive of one another. Other variations to the disclosed embodiments can be understood and effected by those skilled in the art in practicing the claimed invention, from a study of the drawings, the disclosure, and the appended claims.

What is claimed is:

1. A robot comprising a first axle and a second axle, a first axle housing comprising a first transversal axle connected to a rigid structure by a hinge having a first degree of freedom in rotation around a first axis which is vertical and a second degree of freedom in rotation around a second axis which is perpendicular to the first axis and to a first transversal axis, and the axle of the first transversal axle being equipped on either side with a motor, each motor having a stator part configured to be fixed to the first transversal axle and a rotor part configured to be rotatably mounted to a respective wheel to provide steering and propulsion functions.

2. The robot according to claim 1, wherein the robot is further arranged to receive electronic controls configured to control each of the motors fitted to the axle housing.

3. The robot according to claim 2, wherein the electronic controls are configured to drive each motor independently.

4. The robot according to claim 1, wherein the hinge is placed on a center of the transversal axis.

5. The robot according to claim 1, wherein its center of gravity is located between the four wheels.

6. The robot according to claim 1, wherein the chassis is a shell that goes down between the two axles to lower the center of gravity.

7. The robot according to claim 1, wherein the rigid structure is a shell.

8. The robot according to claim 1, comprising a unique battery.

9. The robot according to claim 1, comprising a frontal cutting module located between two wheels, and two other steering wheels.

10. The robot according to claim 1, further comprising four driving wheels.

11. The robot according to claim 2, wherein the electronic controls are configured to implement a robot moving strategy towards a predetermined destination point by minimization of a distance to a predetermined destination point, the strategy being locally random.

12. The robot according to claim 2, comprising an obstacle detector.

13. The robot according to claim 12, wherein the obstacle detector is configured to detect an obstacle by a combination of two or more of the following parameters:
counter electromotive force of one of the motors;
differential of inertial components for detection of acceleration and/or acceleration variation;
angular sensor of steering wheels;
geographical localization.

14. The robot according to claim 11, wherein the electronic controls are configured to invert a direction of movement of the robot when an obstacle is detected.

15. The robot according to claim 11, comprising a frontal cutting module place between two wheels, and wherein, in the event that the obstacle detected is on a side of the cutting tool, the electronic controls are configured to stop the robot and to select a steering direction to circumvent the obstacle before inverting a direction of movement.

16. The robot according to claim 1, comprising an angular sensor of an angle formed by the transverse axle relative to the frame, the angular sensor comprising a flag fixed in rotation with the first axis and a rangefinder to measure a distance between the flag and a fixed point of the rigid structure.

17. The robot according to claim 1, comprising a stop circumscribing in space displacements of the rear axle.

18. The robot according to claim 17, wherein the stop comprises a plate of rectangular shape defining a main plane and a center of the rectangular shape.

19. The robot according to claim 18, wherein a plane orthogonal to the main plane and extending in a longitudinal direction of the plate and passing through the center of the rectangle is a plane of symmetry of the stop.

20. The robot according to claim 18, wherein a plane orthogonal to the main plane and extending in a direction transverse to a longitudinal direction of the plate and passing through the center of the rectangle is a plane of symmetry of the stop.

21. The robot according to claim 18, wherein four screw passages are formed at corners of a rectangle centered on the center of the plate.

22. The robot according to claim 18, wherein four damper passages are formed in the plate at corners of a rectangle centered on the center of the plate.

23. The robot according to claim 18, wherein the stop is one of four stops distributed symmetrically with respect to two planes of symmetry of the stops.

24. The robot according to claim 23, wherein at least one of the stops has a right-angled triangle section whose right angle is disposed at one end of the rectangle forming the plate, one side of the right angle being oriented in the longitudinal direction of the plate, the other side the right angle being directed in the direction of a longitudinal plane perpendicular to the main plane.

25. The robot according to claim 24, wherein in a vertical section transverse to the longitudinal direction of the plate, the plate is hollowed out on a lower central portion to form a “H” which upper left and right interior angles are provided with fillets.
